(19) United States
(12) Patent Application Publication
(10) Pub. No.: US 2010/0166550 A1
(43) Pub. Date: Jul. 1, 2010

(54) METHODS, SYSTEMS AND/OR APPARATUS RELATING TO FREQUENCY-TUNED TURBINE BLADES

(76) Inventors: Siddaraja M. Devangada, Kamataka(s) (IN); Ravindra Kumar, Bihar (IN)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(21) Appl. No.: 12/347,329

(22) Filed: Dec. 31, 2008

(51) Int. Cl. F01D 9/02; B23P 15/02

(52) U.S. Cl. 415/208.1; 29/889.7

(57) ABSTRACT

A method of tuning a compressor stator blade, having a base portion and an airfoil portion, to achieve a desired natural frequency, comprising: a) identifying the natural frequency of the compressor stator blade; b) determining a different target natural frequency for the compressor stator blade; and c) removing material from at least one of the side surfaces of the base portion of the compressor stator blade in an amount and in a configuration that achieves the target natural frequency.

### BACKGROUND OF THE INVENTION

This present application relates generally to methods, systems, and/or apparatus for frequency tuning blades of turbine engines, which, as used herein and unless specifically stated otherwise, is meant to include all types of turbine engines, including gas turbine engines, aircraft engines, steam turbine engines, and rotary engines. More specifically, but not by way of limitation, the present application relates to methods, systems, and/or apparatus pertaining to the manufacture and/or modification of turbine blades such that the frequency of the blades is changed in a manner that improves one or more operational characteristics.

In the past, natural frequency tuning of turbine blades has been accomplished by modifying the shape of the airfoil portion of the blade and or making certain significant modifications to the root portion of the blades. It would be desirable, however, to be able to modify the natural frequency of the airfoil of a turbine blade without having to modify the airfoil shape or make such significant modifications to the root.

### BRIEF DESCRIPTION OF THE INVENTION

The present application thus describes a method of tuning a compressor stator blade, having a base portion and an airfoil portion, to achieve a desired natural frequency, comprising: a) identifying the natural frequency of the compressor stator blade; b) determining a different target natural frequency for the compressor stator blade; and c) removing material from at least one of the side surfaces of the base portion of the compressor stator blade in an amount and in a configuration that achieves the target natural frequency.

The present application further describes a compressor stator blade that includes an airfoil portion and a base portion that is substantially rectangular with side surfaces that include a pressure side, a suction side, a leading face and a trailing face, and a radially inner surface and a radially outer surface, the compressor stator blade comprising at least one groove formed in at least one the side surfaces that is configured such that the compressor stator blade has a desired natural frequency.

These and other features of the present application will become apparent upon review of the following detailed description of the preferred embodiments when taken in conjunction with the drawings and the appended claims.

### BRIEF DESCRIPTION OF THE DRAWINGS

These and other objects and advantages of this invention will be more completely understood and appreciated by careful study of the following more detailed description of exemplary embodiments of the invention taken in conjunction with the accompanying drawings, in which:

FIG. 1 is a schematic representation of an exemplary turbine engine in which certain embodiments of the present application may be used;

FIG. 2 is a sectional view of the compressor section of the gas turbine engine of FIG. 1;

FIG. 3 is a sectional view of the turbine section of the gas turbine engine of FIG. 1;

FIG. 4 is a view of a conventional stator blade design;

FIG. 5 is a view of another conventional stator blade design;

FIG. 6 depicts the general configuration of a base and airfoil;

FIG. 7 is a illustration of a base with side grooves according to an exemplary embodiment of the present invention;

FIG. 8 is a illustration of a base with side grooves according to an exemplary embodiment of the present invention;

FIG. 9 is a illustration of a base with side grooves according to an exemplary embodiment of the present invention;

FIG. 10 is a illustration of a base with side grooves according to an exemplary embodiment of the present invention;

FIG. 11 is a cross-sectional view of an exemplary profile of a side groove;

FIG. 12 is a cross-sectional view of an exemplary profile of a side groove;

FIG. 13 is across-sectional view of an exemplary profile of a side groove;

FIG. 14 is a cross-sectional view of an exemplary profile of a side groove; and

FIG. 15 is a cross-sectional view of an exemplary profile of a side groove.

### DETAILED DESCRIPTION OF THE INVENTION

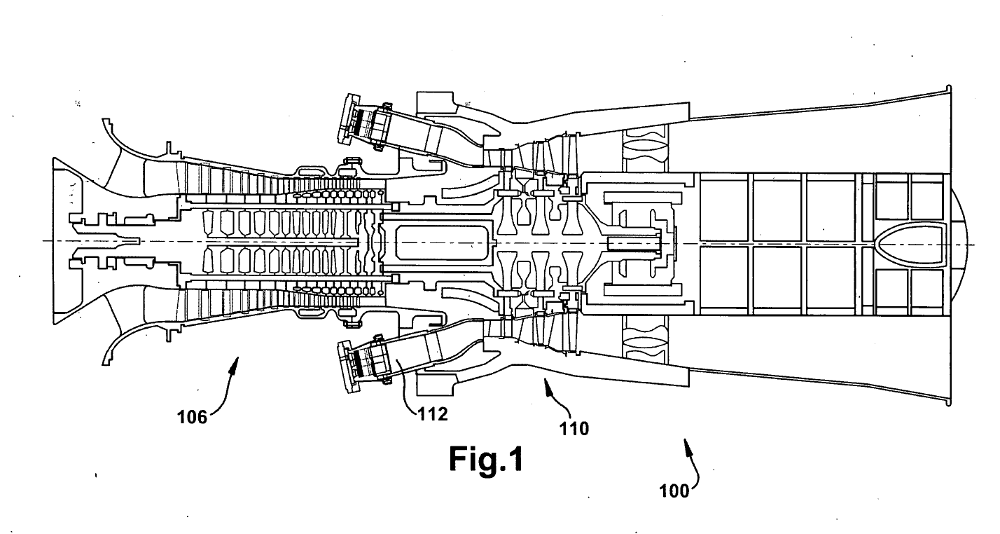

Referring now to the figures, FIG. 1 illustrates a schematic representation of a gas turbine engine 100. In general, gas turbine engines operate by extracting energy from a pressurized flow of hot gas that is produced by the combustion of a fuel in a stream of compressed air. As illustrated in FIG. 1, gas turbine engine 100 may be configured with an axial compressor 106 that is mechanically coupled by a common shaft or rotor to a downstream turbine section or turbine 110, and a combustor 112 positioned between the compressor 106 and the turbine 110. Note that the following invention may be used in all types of turbine engines, including gas turbine engines, steam turbine engines, aircraft engines, and others. Hereinafter, the invention will be described in relation to a gas turbine engine. This description is exemplary only and not intended to be limiting in any way.

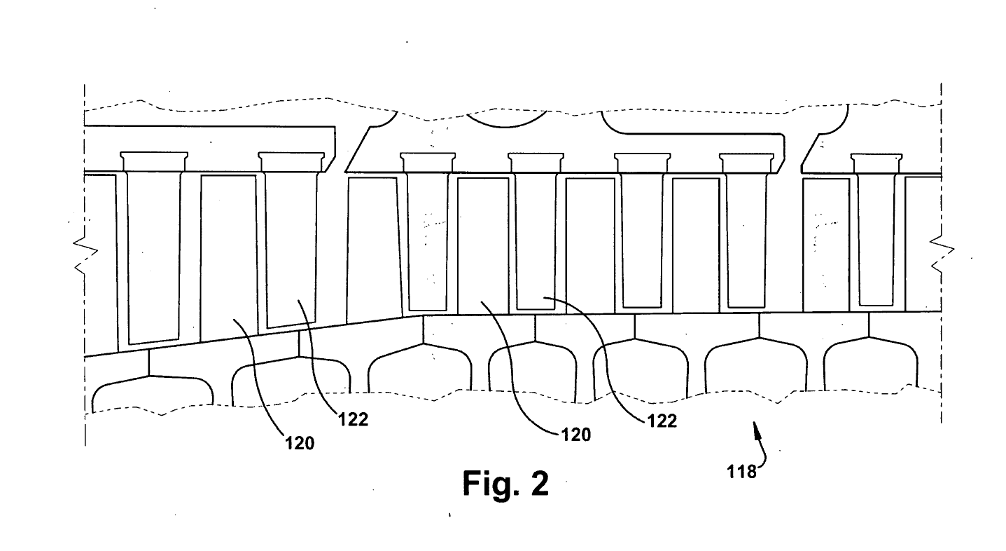

FIG. 2 illustrates a view of an exemplary multi-staged axial compressor 118 that may be used in a gas turbine engine. As shown, the compressor 118 may include a plurality of stages. Each stage may include a row of compressor rotor blades 120 followed by a row of compressor stator blades 122. Thus, a first stage may include a row of compressor rotor blades 120, which rotate about a central shaft, followed by a row of compressor stator blades 122, which remain stationary during operation. The compressor stator blades 122 generally are circumferentially spaced one from the other and fixed about the axis of rotation. The compressor rotor blades 120 are circumferentially spaced and attached to the shaft, when the shaft rotates during operation, the compressor rotor blades 120 rotates about it. As one of ordinary skill in the art will appreciate, the compressor rotor blades 120 are configured such that, when spun about the shaft, they impart kinetic energy to the air or working fluid flowing through the compressor 118. The compressor 118 may have many other stages beyond the stages that are illustrated in FIG. 2. Additional stages may include a plurality of circumferential spaced compressor rotor blades 120 followed by a plurality of circumferentially spaced compressor stator blades 122.

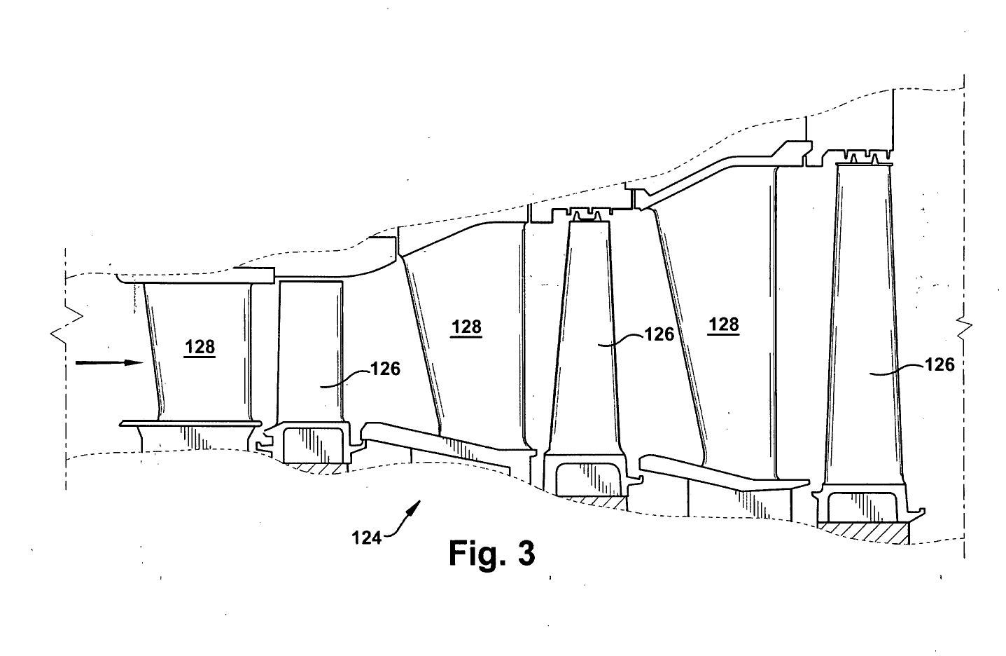

FIG. 3 illustrates a partial view of an exemplary turbine section or turbine 124 that may be used in the gas turbine engine. The turbine 124 also may include a plurality of stages. Three exemplary stages are illustrated, but more or less stages may present in the turbine 124. A first stage includes a plurality of turbine buckets or turbine rotor blades 126, which rotate about the shaft during operation, and a plurality of nozzles or turbine stator blades 128, which remain stationary during operation. The turbine stator blades 128 generally are circumferentially spaced one from the other and fixed about the axis of rotation. The turbine rotor blades 126 may be mounted on a turbine wheel (not shown) for rotation about the shaft (not shown). A second stage of the turbine 124 also is illustrated. The second stage similarly includes a plurality of circumferentially spaced turbine stator blades 128 followed by a plurality of circumferentially spaced turbine rotor blades 126, which are also mounted on a turbine wheel for rotation. A third stage is illustrated, and similarly includes a plurality of turbine stator blades 128 and rotor blades 126. It will be appreciated that the turbine stator blades 128 and turbine rotor blades 126 lie in the hot gas path of the turbine 124. The direction of flow of the hot gases through the hot gas path is indicated by the arrow. As one of ordinary skill in the art will appreciate, the turbine 124 may have many other stages beyond the stages that are illustrated in FIG. 3. Each additional stage may include a row of turbine stator blades 128 followed by a row of turbine rotor blades 126.

Note that as used herein, reference, without further specificity, to “rotor blades” is a reference to the rotating blades of either the compressor 118 or the turbine 124, which include both compressor rotor blades 120 and turbine rotor blades 126. Reference, without further specificity, to “stator blades” is a reference to the stationary blades of either the compressor 118 or the turbine 124, which include both compressor stator blades 122 and turbine stator blades 128. The term “airfoil” will be used herein to refer to either type of blade. Thus, without further specificity, the term “airfoil” is inclusive to all type of turbine engine blades, including compressor rotor blades 120, compressor stator blades 122, turbine rotor blades 126, and turbine stator blades 128.

In use, the rotation of compressor rotor blades 120 within the axial compressor 118 may compress a flow of air. In the combustor 112, energy may be released when the compressed air is mixed with a fuel and ignited. The resulting flow of hot gases from the combustor 112 then may be directed over the turbine rotor blades 126, which may induce the rotation of the turbine rotor blades 126 about the shaft, thus transforming the energy of the hot flow of gases into the mechanical energy of the rotating blades and, because of the connection between the rotor blades in the shaft, the rotating shaft. The mechanical energy of the shaft may then be used to drive the rotation of the compressor rotor blades 120, such that the necessary supply of compressed air is produced, and also, for example, a generator to produce electricity.

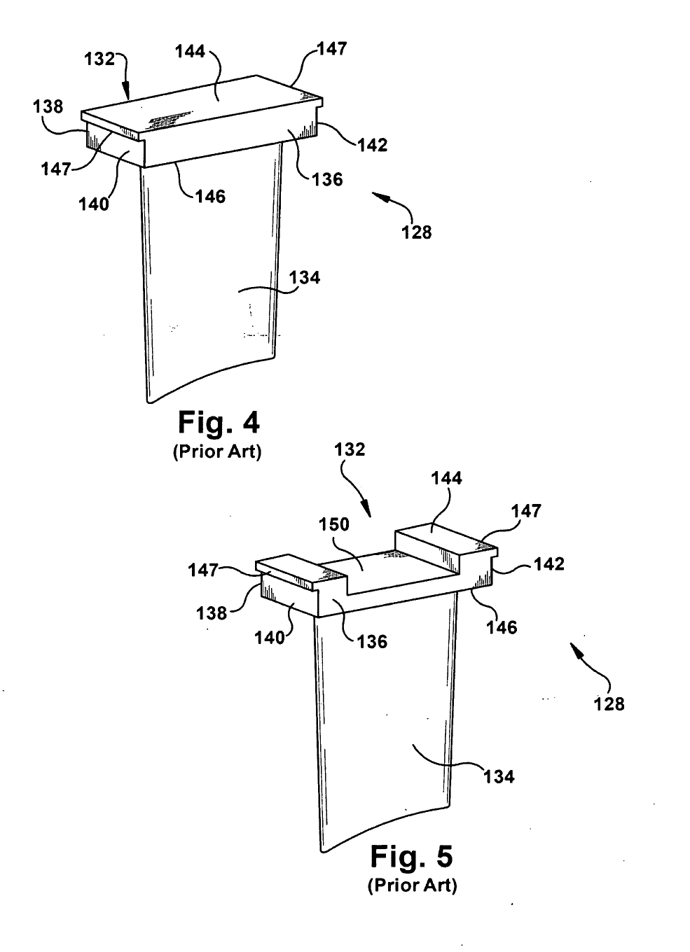

FIGS. 4 and 5 illustrate compressor stator blades 128 of conventional or known design. Generally, stator blades 128 include a mounting portion or base 132 and an airfoil portion or airfoil 134. The base 132 is generally rectangular in shape, with a pair of longer side surfaces 136, 138 and a pair of shorter end surfaces 140, 142, along with a radially outer surface 144 and a radially inner surface 146. When inserted into a properly configured slot (not shown) formed in the turbine casing, it will be appreciated that a pair of tabs or rails 147 along the end surfaces 140, 142 may prevent the radial displacement of the stator blades 128 during operation. The base 132 also may be formed in the shape of a parallelogram, i.e., where the parallel end surfaces are not perpendicular to the parallel side surfaces.

In the past, as with the convention design of FIG. 4, to alter the natural frequency of the airfoil 134, the shape of the airfoil itself had to be modified. As illustrated in FIG. 5, conventional design also includes a method of changing natural frequency by creating a single, wide groove 150 in the radially outer surface 144 of the base 132. The single groove 150 generally includes the removal of a significant amount of material from the base 132 as it extends across the width of the base 132, i.e., from side surface 136 to side surface 138, and approximately parallel to end surfaces 140, 142. It can be seen that the width of the groove 150 substantially spans the entire chord length of the airfoil 134.

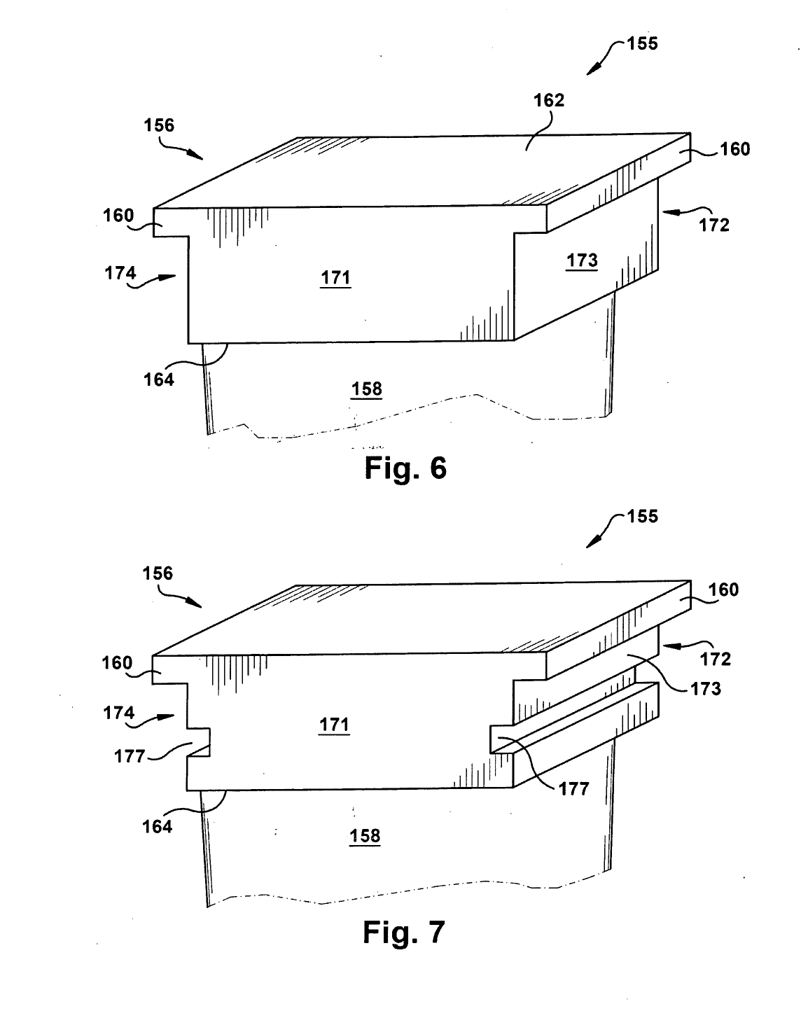

FIG. 6 illustrates a blade 155, the configuration of which will be referenced in the subsequent figures to describe several embodiments of the present application. It will be appreciated that the blade 155 includes a base 156 and an airfoil 158 (of which only a portion is shown). The base 156 includes a rectilinear shape with rails 160 that are used in securing the blade 155 in slots formed in the casing of the turbine. The base 156 generally includes a radially outer surface 162 and a radially inner surface 164. The base 156 also includes four radially-oriented side surfaces: a first side surface 171 that is across from and generally parallel to a second side surface 172, and a third side surface 173 that is across from and generally parallel to a fourth side surface 174. It will be appreciated that side surfaces of the base 156 may include a pressure side and a suction side, which coincide respectively with the pressure side and the suction side of the airfoil, and a leading face and trailing face, which coincide respectively with the leading edge and trailing edge of the airfoil. For the sake of this example, the first side surface 171 and the second side surface 172 may be the pressure side and suction side, respectively, and the third side surface 173 and the fourth side surface 174 may be the leading face and the trailing face, respectively.

FIG. 7 illustrates a modified stator blade 155 in accordance with a non-limiting exemplary embodiment of the present application. In this embodiment, the stator blade 155 generally is similar to and includes the same components as that described above for the blade in FIG. 6. In addition, though, the stator blade 155 includes a side groove 177 along the third side surface 173 and the fourth side surface 174. As used herein, reference to a “side groove,” without further specification, is meant to have the broadest interpretation or meaning. That is, reference to a side groove is meant to broadly include any depression, groove, notch, trench, or similar formation that extends, whether continuously or intermittently, across one of the sides 171, 172, 173, 174 of the base 156. The side groove 177 illustrated in FIG. 7, for example, may be described as a groove with a rectangular profile that extends in a continuous manner across the length of the third side surface 173 and the fourth side surface 174, which, respectively, may be the leading face and trailing face of the base 156. The side groove 177 of FIG. 7, however, is exemplary only. As will be discussed in more detail below, side grooves according to the present invention may come in many shapes, sizes, and/or configurations.

The particular configuration of the side groove 177 may be determined as follows. After having determined the natural frequency of the blade 155 and after having identified a target natural frequency, one or more of the side surfaces 171, 172, 173, 174 of the stator blade 155 is modified by selectively removing material from one or more of them in the form of a side groove. Material is removed until the target natural frequency for the blade 155 is achieved. A side groove 177 may be formed in the base 156 by cutting or machining to the desired geometry. As illustrated, in preferred embodiments, the groove 177 may extend such that it is parallel to the edges of the side surfaces 173, 174. Also, in preferred embodiments, the groove 177 also may have a constant depth and a constant width.

It will be appreciated by those skilled in the art that the amount of material removed from the side surfaces is dependent upon the desired or target natural frequency. Thus, the width and the depth of the groove 177 may be altered as necessary to achieve the targeted natural frequency. In some embodiments, the width and depth may not be constant across the the side surface. Further, in some embodiments, the desired frequency may also be achieved by forming one or more additional grooves 177 of the same or different size and shape across the third 173 and fourth side surface 174.

The removal of material from the stator blade base or mounting portion for purposes of tuning the natural frequency of the airfoil is a concept that may not only be retrofitted into existing compressor stator blades, but also used in the initial design and manufacture of stator blades. The ability to utilize the invention in existing stator blades provides a relatively quick hardware solution to a frequency related issue as compared to the normal cycle for the production of a new stator blade with a modified airfoil shape.

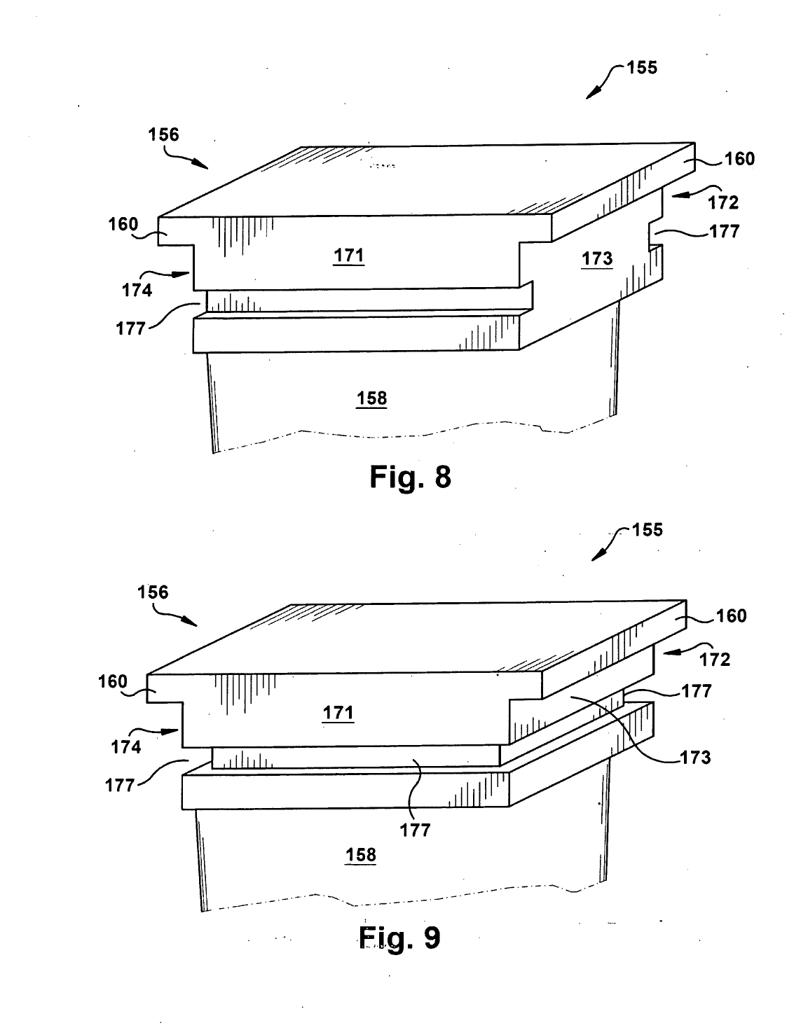

FIGS. 8 through 10 illustrate alternative embodiments, any of which may be used to achieve the desired target natural frequency. While these figures illustrate examples of alternative side groove 177 configurations, it will be appreciated that the criteria and design options discussed above apply for each. FIG. 8 illustrates side grooves 177 that are similar to the ones shown in FIG. 7 except the location is in the first 171 and second side surfaces 172, which, respectively, may be the pressure and suction side of the blade 155. FIG. 9 illustrates side grooves 177 that wrap around all four of the sides 171, 172, 173, 174 of the base 156.

FIG. 10 illustrates an exemplary embodiment, which is similar to FIG. 7 (i.e., side grooves in the third side surface 173 and the fourth side surface 174) except for the addition of tapering rails 185. It will be appreciated by those skilled in the art that the size and angle of the tapering rails 185 may be manipulated to alter the frequency of the blade 155 to achieve a target natural frequency. Accordingly, in some embodiments, the size and angle of the tapering rails 147 of the groove 177 may be altered as necessary to achieve the targeted natural frequency. This may be done in conjunction with or separately from the side grooves 177 described above.

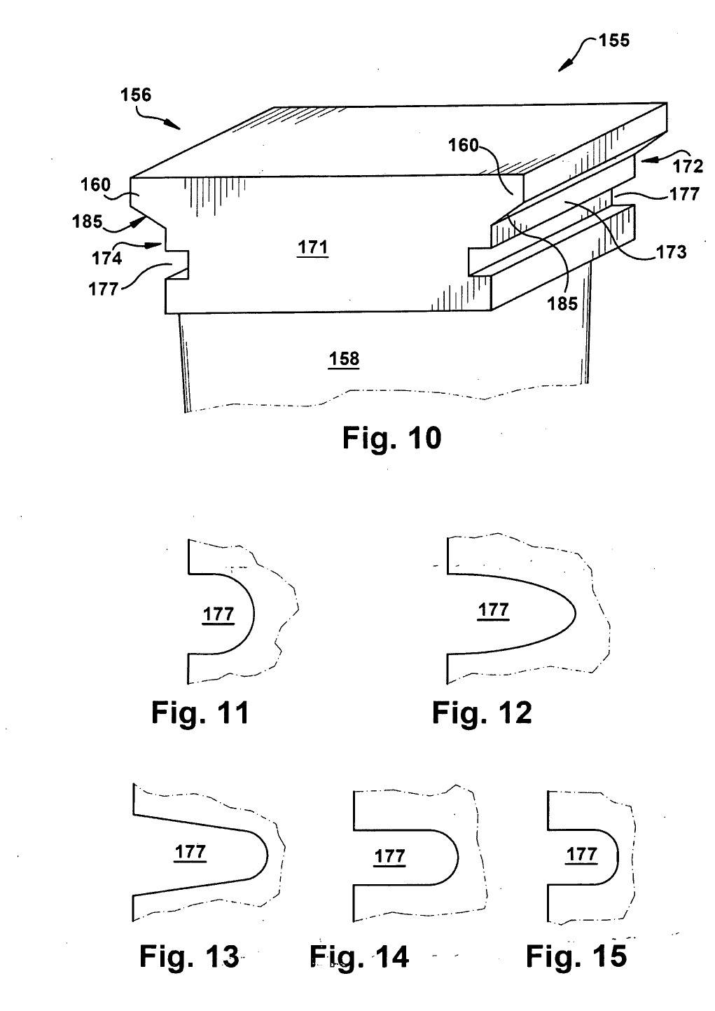

FIGS. 11 through 15 illustrate some preferred cross-sectional shapes for the side groove 177. FIG. 11 illustrates a semi-circular profile. FIG. 12 illustrates a semi-oval shape. FIG. 13 is a conical shape with a rounded end. FIG. 14 depicts a rectangular shape that terminates into a semi-circular shape. FIG. 15 is a rectilinear shape that is similar to the examples of FIGS. 7 through 10, but has rounded corners or fillets.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A method of tuning a compressor stator blade, having a base portion and an airfoil portion, to achieve a desired natural frequency, comprising:
a) identifying the natural frequency of the compressor stator blade;
b) determining a different target natural frequency for the compressor stator blade; and
c) removing material from at least one of the side surfaces of the base portion of the compressor stator blade in an amount and in a configuration that achieves the target natural frequency.

2. The method of claim 1, wherein step c) is carried out by forming at least one groove in at least one of the side surfaces of the base portion.

3. The method of claim 2, wherein the groove is a slot with an approximate rectangular cross-section.

4. The method of claim 1, wherein step c) is carried out by forming at least one groove in each of two side surfaces that are substantially parallel to each other.

5. The method of claim 2, wherein:
the side surfaces include a pressure side, a suction side, a leading face and a trailing face;
the pressure side and suction side are across from and substantially parallel to each other, and the leading face and the trailing face are across from and substantially parallel to each other; and
step c) is carried out by forming at least one groove in each of the pressure side and suction side.

6. The method of claim 2, wherein:
the side surfaces include a pressure side, a suction side, a leading face and a trailing face;
the pressure side and suction side are across from and substantially parallel to each other, and the leading face and the trailing face are across from and substantially parallel to each other; and
step c) is carried out by forming at least one groove in each of the trailing face and leading face.

7. The method of claim 2, wherein:
the side surfaces include a pressure side, a suction side, a leading face and a trailing face;
the pressure side and suction side are across from and substantially parallel to each other, and the leading face and the trailing face are across from and substantially parallel to each other; and
step c) is carried out by forming at least one groove in each of the pressure side, the suction side, the trailing face and leading face.

8. The method of claim 4 wherein said groove has substantially parallel sides and a substantially flat base.

9. The method of claim 4 wherein each of said grooves has a constant depth.

10. The method of claim 4 wherein each of said grooves has a constant width.

11. The method of claim 4 wherein each of said grooves has a constant depth and a constant width.

12. The method of claim 4 wherein each of said grooves extends fully across the length of each of the side surfaces.

13. The method of claim 4 wherein said base portion is substantially rectangular, with a pair of relatively longer side surfaces, a pair of relatively shorter end surfaces, a radially inner surface and a radially outer surface.

14. The method of claim 4, wherein the cross-sectional profile of the groove is one of rectangular, semi-circular, semi-oval shape, conical shape with a rounded end, rectangular shape that terminates into a semi-circular shape, and a rectangular shape that has corner fillets.

15. The method of claim 2, wherein:
the base portion includes one or more rails; and
step c) is carried out by also removing material from at least one of the rails so to form a tapering rail.

16. A compressor stator blade that includes an airfoil portion and a base portion that is substantially rectangular with side surfaces that include a pressure side, a suction side, a leading face and a trailing face, and a radially inner surface and a radially outer surface, the compressor stator blade comprising at least one groove formed in at least one the side surfaces that is configured such that the compressor stator blade has a desired natural frequency.

17. The compressor stator blade according to claim 16, wherein compressor stator blade comprises at least one groove formed in the pressure side and the suction side.

18. The compressor stator blade according to claim 16, wherein compressor stator blade comprises at least one groove formed in the leading face and the trailing face.

19. The compressor stator blade according to claim 16, wherein:
the pressure side and suction side are across from and substantially parallel to each other, and the leading face and the trailing face are across from and substantially parallel to each other; and
the groove has a substantially constant depth, a substantially constant width, and extends fully across the width of the base portion.

20. The compressor stator blade according to claim 16, wherein the cross-sectional profile of the groove is one of rectangular, semi-circular, semi-oval shape, conical shape with a rounded end, rectangular shape that terminates into a semi-circular shape, and a rectangular shape that has corner fillets.
